(19) United States
(12) Patent Application Publication
(10) Pub. No.: US 2021/0146518 A1
(43) Pub. Date: May 20, 2021

(54) HAND GUARD FOR A BEARING FITTING TOOL AND BEARING FITTING TOOL HAVING A HAND GUARD MOUNTED THEREON

(71) Applicant: AKTIEBOLAGET SKF, GOTEBORG (SE)

(72) Inventor: Arjan van Os, Alphen aan den Rijn (NL)

(21) Appl. No.: 17/081,105

(22) Filed: Oct. 27, 2020

(30) Foreign Application Priority Data
Nov. 19, 2019 (DE) 102019217790.5

(51) Int. Cl. B25D 1/16; B25D 1/12; F16C 43/02

(52) U.S. Cl. CPC B25D 1/16; F16C 43/02; B25D 1/12

(57) ABSTRACT

A hand guard configured to be mounted on a bearing fitting tool includes a deflector plate having a central opening and a connector mounted in the central opening, the connector being configured to connect the deflector plate to the bearing fitting tool and including a damping body configured to damp a force acting on the hand guard.

### CROSS-REFERENCE

This application claims priority to German patent application no. 10 2019 217 790.5 filed on Nov. 19, 2019, the contents of which are fully incorporated herein by reference.

### TECHNOLOGICAL FIELD

The present disclosure is directed to a hand guard for a bearing fitting tool and to a bearing fitting tool having the hand guard mounted thereon.

### BACKGROUND

It is sometime necessary to use a bearing fitting tool to apply a force against a bearing to mount the bearing and/or to fit the bearing into a bearing seat. The fitting tool may include an elongated body having a striking element or striking surface at one end that is intended to be hit with a hammer to apply a force through the fitting tool to the bearing. In use, a person usually holds the bearing fitting tool with one hand while striking the striking end of the fitting tool with a hammer. If the user misses the striking element, there is a risk that the hammer will hit the user's hand and injure the user.

### SUMMARY

It is therefore an aspect of the present disclosure to improve user safety when fitting a bearing with a bearing fitting tool.

The disclosure is directed to a hand guard which comprises a plate configured to deflect a force acting on the plate away from the hand of a user gripping the fitting tool and a damping connector configured connect the plate to the fitting tool and to damp impact forces acting on the plate and reduce forces transmitted from the plate to the user's hand.

When a bearing fitting tool is used to fit a bearing in its respective seat, a user may fit the bearing fitting tool on a bearing while holding the bearing fitting tool with one hand and striking an intended striking element of the bearing fitting tool with a hammer. The bearing fitting tool thereby transmits the striking force of the hammer via the bearing fitting tool to the bearing which results in the bearing being fitted in its seat. In case that the user misses the intended striking element of the bearing fitting tool, the hammer will hit the hand guard, particularly the plate of the hand guard, and the risk that the user injures his or her hand holding the bearing fitting tool is reduced, thereby the user safety is improved.

Preferably, the plate has a central opening that is adapted to receive the damping element such that the plate and the damping element can be coupled to each other in a simple manner. Furthermore, the damping element can be connected to a bearing fitting tool in a form-fit manner, a force-fit manner and/or a material-fit manner. This may allow for easily connecting the damping element to the fitting element in a secure and/or reversible manner. Moreover, the plate may have a rectangular shape, a circular shape or an oval shape. Preferably, the plate is a square which has the advantage that an area of the plate is smaller compared to plate with a circular shape and the same diameter as an edge length of the square. Also, a square may be easily fitted into a tool case.

According to a further embodiment, the plate is made using a molding process, such as injection molding. More specifically, molding processes such as injection molding allow the plate and its structures to be formed in any desired manner in a simple and efficient way. Preferably, the plate is made of plastic, particularly a hard plastic such as polyethylene, which can bear up against large striking forces.

According to a further embodiment, the damping element is also formed by a molding process such as injection molding, which allows to form the damping element and its structures to be formed in any desired shape in a simple manner. It is further advantageous that the damping element is made from a material which has dampening and/or shock absorption characteristics such as rubber, more particularly moldable rubber for injection molding. In addition, rubber may have a higher friction which may aid in the connection between the damping element and the bearing fitting tool.

Preferably, the damping element may have a radially outwardly facing circumferential receiving groove for receiving the plate, and the opening of the plate is adapted to be snapped into the groove. Thus, the plate can be connected to the damping element in a simple manner. Also, by snapping the plate into the groove of the damping element, it is also possible to easily replace the plate, for example if the plate is broken or if the plate needs to be exchanged to another plate having a different size and/or shape. Alternatively, it is also possible to manufacture the plate and the damping element as one combined part using an appropriate molding process such as integrate injection molding. In this case, the connection between the plate and the damping element may be more robust.

In order to facilitate the connection between the damping element and a shaft of a bearing fitting tool, the damping element may further have a central hole into which an end of the bearing fitting tool is insertable. The central hole of the damping element can be a through hole or a blind hole. This allows the damping element to be simply attached to the shaft of the bearing fitting tool by a friction fit and/or a form fit, whereas a blind hole may serve as a stop, which also provides an axial positioning of the damping element on the shaft of the bearing fitting tool.

Additionally or alternatively, the damping element may be made longer such that it extends onto the bearing fitting tool and provides a grip for the user. More specifically, if the damping element is made of a rubber material, such an extension of the damping element onto the bearing fitting tool may make the bearing fitting tool easier for the user to handle.

Advantageously, the plate has at least one first reinforcement structure and/or at least one second reinforcement structure, enforcing the plate against the impact force acting on the plate in case the user misses the striking element and hits the hand guard with a hammer. Preferably, the first reinforcement structure is circumferentially arranged around the central opening of the plate and/or the second reinforcement structure extends axially and/or radially outwardly from the central opening towards an edge of the plate. Thereby, the first reinforcement structure may reinforce the central opening of the plate while the second reinforcement structure may reinforce the outer parts of the plate. In this way, the force on the plate may be absorbed by the plate which improves the stability of the plate and thereby the user safety. More particularly, the type and/or number of reinforcement structures may be chosen depending on a size, particularly a diameter, of the plate and/or of the central opening in the plate.

According to a further preferred embodiment, the damping element has at least one force-deflecting element configured to deflect a force acting on the plate and to reinforce the hand guard, particularly the damping element, wherein the force-deflecting element is circumferentially arranged around the central hole of the damping element. The at least one force-deflecting element may be provided in form of discrete elements or as a continuous element. More particularly, the force-deflecting element may be designed as a plurality of ribs each extending radially outwardly and/or axially. Advantageously, the force-deflecting element may allow for distributing the force on the plate and/or the damping element in a more even manner. This can also increase a stability of the damping element and thereby of the hand guard.

A further aspect of the present invention relates to a bearing fitting tool for fitting a bearing, wherein the bearing fitting tool comprises a cylindrical shaft having a first end and a second end which are opposite to each other along a longitudinal direction of the shaft. The first end is adapted to cooperate directly or indirectly, for example via an impact ring, with a bearing to be fitted and an end cap is arranged at the second end of the shaft. More particularly, the impact ring may be adapted to a size of the bearing such that it can be avoided that the sleeve rests directly upon the bearing.

The end cap serves as a striking element and is therefore configured to receive and transmit an impact force via the shaft to the bearing such that the bearing can be fitted. Further, the above-mentioned hand guard is arranged at one end of the shaft such that the plate of the hand guard extends over the shaft. More specifically, the bearing fitting tool has the advantage that the hand guard improves user safety.

Preferably, the shaft is a hollow sleeve, which causes the bearing fitting tool to be lighter and/or more robust. Also, a lighter bearing fitting tool may be easier for the user to handle. In particular, the sleeve can be made from a metallic material such as aluminum and/or a plastic material such as glass-fiber reinforced plastics. A metallic sleeve may allow for a better transmission of the striking force to the bearing, whereas a sleeve made from a plastic material may be lighter.

Advantageously, the end cap is made from a plastic material, preferably hard plastic, using a molding process such as injection molding. A hard, non-metallic material such as hard plastic may withstand the applied striking force while reducing any noises that are generated when striking the striking element with a hammer. The end cap or striking element may be form-fitted, force-fitted and/or material-fitted on the first end of the shaft/sleeve of the bearing fitting tool. Also, the end cap and the sleeve can be formed as one piece. For example, when forming the sleeve from glass-fiber reinforced plastics, the sleeve may be molded with an integrated end cap or striking element.

According to a further preferred embodiment, the sleeve has a circumferential recess (or portion of reduced diameter) for receiving the damping element and determining its axial position at the sleeve, wherein an end of the recess is configured to provide a stop for the damping element. Thereby, the hand guard may be prevented from being dislocated. The recess of the sleeve may be formed using a machining process and/or by providing at least one rib on the sleeve, wherein the at least one rib is formed on an outside of the sleeve and extends along the longitudinal direction of the sleeve. Moreover, the rib may strengthen the sleeve against the transmitted force that is applied to the end cap.

As mentioned above, it may also be possible to make the damping element longer such that it extends onto the sleeve of the bearing fitting tool in order to provide a grip for the user. More particularly, the damping element may be even so long such that it extends to the second end of the sleeve and provides a hand grip for the user. This has the advantage that a stop that provides the axial positioning of the hand guard can be omitted.

Alternatively, the sleeve can be provided with a plurality of ribs, each extending along the longitudinal direction of the sleeve, wherein the plurality of the ribs is preferably evenly circumferentially distributed around the sleeve. Having a plurality of ribs may have the advantage that an additional machining step which forms the recess on the sleeve can be omitted.

Further preferred embodiments are defined in the dependent claims as well as in the description and the figures. Thereby, elements described or shown in combination with other elements may be present alone or in combination with other elements without departing from the scope of protection.

In the following, preferred embodiments of the invention are described in relation to the drawings, wherein the drawings are exemplarily only, and are not intended to limit the scope of protection. The scope of protection is defined by the accompanied claims, only.

### BRIEF DESCRIPTION OF THE DRAWINGS

FIG. 1 is a schematic exploded view of a bearing fitting tool according to an embodiment of the present invention.

FIG. 2 is a schematic exploded view of a sleeve and an end cap of the bearing fitting tool shown in FIG. 1.

FIG. 3 is a side elevational view of the damping element of the hand guard of the bearing fitting tool shown in FIG. 1.

FIG. 4 is a sectional side elevational view taken along line A-A in FIG. 3.

FIG. 5 is an isometric exploded view of a hand guard of the bearing fitting tool shown in FIG. 1.

FIG. 6 is a side elevational view of an assembled hand guard according to an embodiment of the invention.

### DETAILED DESCRIPTION

In the following same or similar functioning elements are indicated with the same reference numerals.

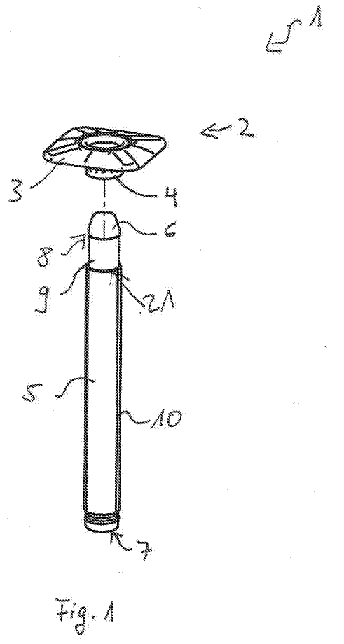

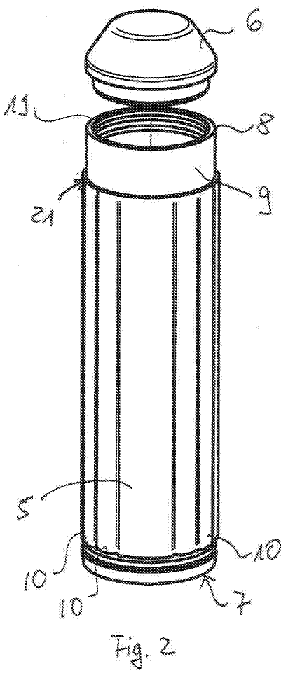

FIG. 1 shows a schematic, exploded view of a bearing fitting tool 1 according to an embodiment of the present disclosure. Details of the bearing fitting tool 1 are shown in FIGS. 2 to 6.

The bearing fitting tool 1 has a cylindrical sleeve 5 and an end cap 6. The sleeve 5 is preferably made from a lightweight material, such as aluminum or a glass-fiber reinforced plastic, and has a first end 7 and a second end 8 which are opposite to each other along a longitudinal direction of the sleeve 5.

The first end 7 is adapted to cooperate with a bearing (not shown) to be fitted, whereas the end cap 6 is arranged at the second end 8 of the sleeve 5. The end cap 6 is preferably made from a plastic material, e.g. hard plastic, and is configured to receive a striking force and transmit the striking force via the sleeve 5 to the bearing such that the bearing can be fitted.

For fitting a bearing in its respective seat, the user fits the first end 7 of the sleeve 5 of the bearing fitting tool 1 directly or indirectly, for example via an impact ring (not shown), on the bearing to be fitted while holding the bearing fitting tool 1 with one hand and hits the end cap 6 of the bearing fitting tool 1, which is located at the second end 8 of the sleeve 5, with a striking tool such as a hammer. In other words, the end cap serves as a striking element.

The bearing fitting tool 1 then transmits the striking force of the hammer via the sleeve to the bearing which results in the bearing being fitted in its seat. If the user misses the end cap 6 of the bearing fitting tool 1, the user could strike his or her hand with the hammer. To protect the user's hand, the bearing fitting tool 1 may be provided with a hand guard which comprises a plate 3 and a damping element 4. As can be seen in FIG. 1, the hand guard 2 is arranged between the sleeve 5 and the end cap 6 and may be attached to the sleeve 5 by the damping element 4. Thus, the damping element 4 also serves as a connector for fixing the plate 3 to the sleeve 5. In the assembled state, the plate 3 of the hand guard 2 extends over the sleeve 5, so that a misplaced impact of the hammer will hit the hand guard 2, particularly the plate 3 of the hand guard 2, instead of the hand of the user. Consequently, the risk of hand injuries is reduced.

For mounting the hand guard 2 to the bearing fitting tool 1, the sleeve 5 has a circumferential recess 9 (region of reduced diameter) which provides an axial stop 21 for the damping element 4 and receives the damping element 4 and determines its axial position at the sleeve 5. In the embodiment of FIG. 1, the recess is machined to the sleeve 5.

As illustrated in the embodiment shown in FIG. 2, the sleeve 5 may be equipped with a plurality of ribs 10, wherein each rib 10 is formed on an outside of the sleeve 5 and extends in the longitudinal direction of the sleeve 5. Thereby, the plurality of ribs 10 forms an axial stop such that the separate machining step for forming the recess can be omitted. As can be further seen, the first end 8 of the sleeve 5 may be provided with a thread 19 for connecting the end cap 6 to the sleeve 5. However, other fastening arrangements for connecting the end cap 6 to the sleeve 5 can be used.

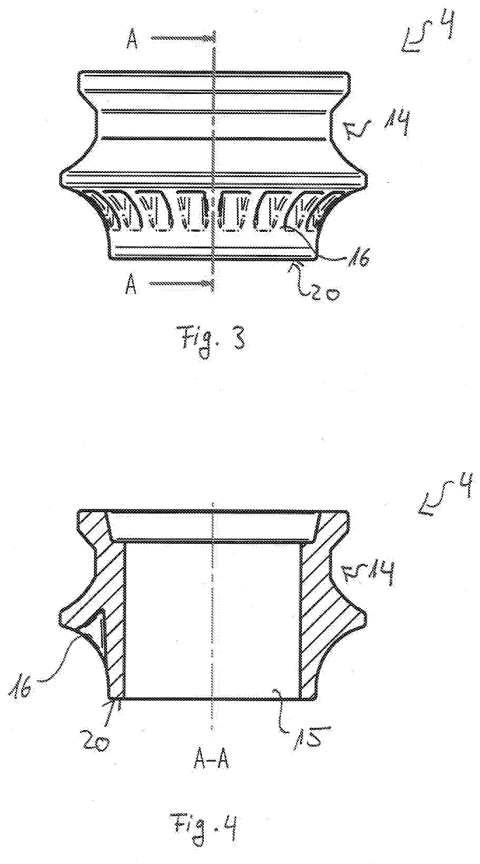

For fitting the damping element 4 to the sleeve 5, the damping element 4 has a central hole 15, see FIGS. 4 and 5, into which the sleeve 5 of the bearing fitting tool 1 is insertable. The central hole 15 of the damping element 4 is formed as a through hole and is dimensioned to closely conform to the sleeve 5, i.e. to fit onto the recess 9. Thereby, an edge 20 (FIGS. 3 and 4) of the damping element 4 may abut on the stop 21 formed by the recess 9.

Advantageously, the damping element 4 is injection molded from a material that has dampening and/or shock absorbing characteristics, such as moldable rubber. Furthermore, rubber has the additional advantage that it has a rather high coefficient of friction with the metallic material of the sleeve 5 which further aids in the coupling between the damping element 4 and the sleeve 5.

The damping element 4 also has at least one force-deflecting element 16 configured to deflect the striking force acting on the plate 3 and to reinforce the damping element 4. The force-deflecting element 16 is formed as a plurality of ribs 16 that are circumferentially arranged around the central hole 15 of the damping element 4. Each of the ribs is formed such that it extends both axially and radially outwardly as shown in FIGS. 3 and 4.

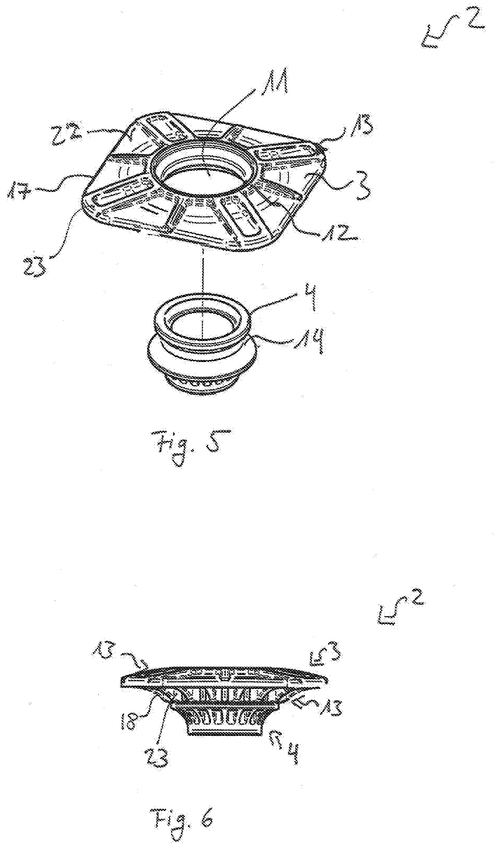

As further illustrated in FIGS. 3, 4, and 5, the damping element 4 has a circumferential extending receiving groove 14 which is adapted to cooperate with a central opening 11 of the plate 3 (see FIG. 5). Thereby, the central opening 11 is adapted to be snapped into the groove 14 of the damping element 4. This snap-in function allows for a simple and efficient connection between the damping element 4 and the plate 3. The assembled state of the plate 3 and the damping element 4 is shown in FIG. 6.

In order to better withstand the impact force on the plate 3, the plate 3 has a plurality of reinforcement structures 12, 13, which are illustrated in FIGS. 5 and 6. A first reinforcement structure 12 is circumferentially arranged around the central opening 11 of the plate 3 and can be arranged on top 22 of the plate 3 and/or at the opposite side 18. The first reinforcement structure 12 provides an increased stability and a seat for the connection of the damping element 4.

A second reinforcement structure 13 is designed as ribs 23, which are extending axially and radially outwardly from the central opening 11 towards an edge 17 of the plate 3. As can be seen from FIGS. 5 and 6, the ribs 23 are arranged both on the top side 22 of the plate 3 and at the opposite bottom side 18 of the plate 3 and reinforce the plate 3 against the striking force.

In summary, the hand guard 2 is able to improve a user safety, when arranged at a bearing fitting tool 1, by protecting the user from a striking force that is applied to the bearing fitting tool. Furthermore, several reinforcement and force-damping structures 12, 13, 16 are arranged both at the plate 3 and the damping element 4 of the hand guard 2 to strengthen the hand guard 2 against the impact force.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide hand guards for bearing fitting tools.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMERAL LIST

1 Bearing fitting tool
2 Hitting guard
3 Plate
4 Damping element
5 Sleeve
6 End cap
7 First end
8 Second end
9 Recess
10 Rib
11 Opening
12 First reinforcement structure
13 Second reinforcement structure
14 Groove
15 Hole
16 Force-deflecting element
17 Edge
18 Bottom
19 Thread
20 Edge
21 Stop
22 Top
23 Rib

What is claimed is:

1. A hand guard configured to be mounted on a bearing fitting tool, the bearing fitting tool having a striking surface, the hand guard comprising:
a deflector plate having a central opening, and
a connector mounted in the central opening, the connector being configured to connect the deflector plate to the bearing fitting tool and comprising a damping body configured to damp a force acting on the hand guard.

2. The hand guard according to claim 1, wherein the deflector plate is formed form a first material and the connector is formed from a second material different than the first material.

3. The hand guard according to claim 2,
wherein the damping body includes a radially outwardly facing circumferential groove for receiving the deflector plate, and
wherein the central opening of the deflector plate is snappable into the groove.

4. The hand guard according to claim 2,
wherein the damping body has a central hole configured to receive an end of the bearing fitting tool.

5. The hand guard according to claim 2,
wherein the deflector plate has at least one reinforcing structure, the reinforcing structure comprising a reinforcing ring around the central opening and/or a rib extending radially from the central opening.

6. The hand guard according to claim 2,
wherein the damping body has at least one force-deflecting element configured to deflect a force acting on the plate, and
wherein the force-deflecting element is circumferentially arranged around the central hole of the damping body.

7. The hand guard according to claim 6, wherein the force-deflecting element includes a plurality of radially outwardly extending ribs.

8. The hand guard according to claim 2, wherein the damping element is configured to connect to the bearing fitting tool in a form-fit manner, a force-fit manner and/or a material-fit manner.

9. The hand guard according to claim 2, wherein the first material is polyethylene.

10. The hand guard according to claim 2, wherein the second material is rubber.

11. The hand guard according to claim 2,
wherein the damping body includes a radially outwardly facing circumferential groove for receiving the deflector plate,
wherein the central opening of the deflector plate is snappable into the groove,
wherein the damping body has a central hole configured to receive an end of the bearing fitting tool,
wherein the deflector plate has at least one reinforcing structure, the reinforcing structure comprising a reinforcing ring around the central opening and/or a rib extending radially from the central opening,
wherein the damping body includes a plurality of radially outwardly extending ribs,
wherein the first material is polyethylene, and
wherein the second material is rubber.

12. A bearing fitting tool for fitting a bearing, comprising:
a cylindrical shaft having a first end and a second end which are opposite to each other along a longitudinal direction of the shaft, wherein the first end is configured to cooperate with a bearing to be fitted,
an end cap arranged at the second end of the shaft and configured to receive a force and transmit the force via the shaft to the bearing, and
a hand guard according to claim 1 arranged at the second end of the shaft.

13. The bearing fitting tool according to claim 12,
wherein the shaft has a stop surface and the connector is supported by the stop surface.
